(19) United States
(12) Patent Application Publication
(10) Pub. No.: US 2024/0391330 A1
(43) Pub. Date: Nov. 28, 2024

(54) STEEL TAILOR WELDED BLANK STAMPED BATTERY TRAY

(71) Applicant: Cleveland-Cliffs Steel Properties Inc., Cleveland, OH (US)

(72) Inventors: Feng Zhu, LaSalle (CA); Miao Yu, Northville, MI (US); Sobhan T. Nazari, Novi, MI (US); Panagiotis Makrygiannis, Windsor (CA); Jimmy Zhang, Troy, MI (US); Sajan G. Elengikal, Novi, MI (US); Yu-Wei Wang, Farmington Hills, MI (US)

(21) Appl. No.: 18/660,570

(22) Filed: May 10, 2024

Related U.S. Application Data
(60) Provisional application No. 63/468,332, filed on May 23, 2023.

(51) Int. Cl. B60L 50/64; B60K 1/04

(52) U.S. Cl. CPC B60L 50/64; B60K 1/04; B60K 2001/0438

(57) ABSTRACT

An apparatus for containing a portion of a vehicle battery assembly incudes a tray. The tray is configured to receive the portion of the vehicle battery assembly. The tray defines a floor, a front wall, a rear wall, and a pair of sidewalls extending from the front wall to the rear wall. The tray includes a first steel material and a second steel material. The first steel material is joined with the second steel material to form a single contiguous part. The first steel material defines a substantial majority of the floor. The second steel material is disposed at two or more corners of the tray.

### PRIORITY

This application claims priority to U.S. Provisional Application Ser. No. 63/468,332, entitled “Steel Tailor Welded Blank Stamped Battery Tray,” filed on May 23, 2023, the disclosure of which is incorporated by reference herein.

### BACKGROUND

Some vehicles may include certain vehicle battery systems. For instance, in electric vehicles, which may be entirely powered by electric power, vehicle battery systems may be provided to supply all power to the vehicle for propulsion and powering of accessory electrical systems. Similarly, in certain hybrid vehicles, which may be powered by a combination of electric power and combustion power, vehicle battery systems may be provided to supply at least some power to the vehicle for propulsion and powering of accessory electrical systems.

In such vehicles, vehicle battery systems may be sensitive to damage from a variety of environmental factors encountered when driving in various climates and topographies. Such environmental factors may include the possibility of collision between the vehicle and other objects encountered during travel such as other vehicles, objects near roadways, or roadway debris. Other such environmental factors may include naturally occurring conditions such as humidity, rain, ice, snow, hail, etc. Thus, to avoid damage to sensitive vehicle battery systems, such vehicle battery systems may be located and/or contained within various battery containment structures to protect one or more components of such vehicle battery systems from such environmental factors.

Examples of battery containment structures are described in the following patents or publications: U.S. Pat. No. 10,886,513, entitled “Vehicle Battery Tray Having Tub-Based Integration,” issued on Jan. 5, 2021; U.S. Pat. No. 10,483,510, entitled “Polarized Battery Tray for Vehicle,” issued on Nov. 19, 2019; and WO 2022/197830, entitled “Vehicle Battery Tray and Method of Manufacturing the Same,” published on Sep. 22, 2022. The disclosures of which are hereby incorporated by reference herein in their entirety.

While a variety of battery containment structures have been made and used, it is believed that no one prior to the inventor(s) has made or used an invention as described herein.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a perspective view of an example of a vehicle chassis including a battery containment structure;

FIG. 2 depicts a perspective exploded view of the battery containment structure of FIG. 1;

FIG. 3 depicts a perspective view of a battery tray of the battery containment structure of FIG. 1;

FIG. 4 depicts a top plan view of the battery tray of FIG. 3;

FIG. 5 depicts a perspective view of an illustrative alternative battery tray that may be readily incorporated into the battery containment structure of FIG. 1;

FIG. 6 depicts a top plan view of the battery tray of FIG. 5;

FIG. 7 depicts a top plan view of a blank used to form the battery tray of FIG. 5;

FIG. 8 depicts a top plan view of another blank used to form the battery tray of FIG. 5;

FIG. 9 depicts a perspective view of another illustrative battery tray for use in the battery containment structure of FIG. 1;

FIG. 10 depicts top detailed heat maps of a digital model of the battery tray of FIG. 9 after being subjected to a computer simulated stamping operation;

FIG. 11 depicts a perspective heat map of a digital model of the battery tray of FIG. 9 after being subjected to a computer simulated ballistics impact;

FIG. 12 depicts a plot of force versus displacement for the computer simulated ballistics impact of FIG. 11;

FIG. 13 depicts a perspective view of yet another illustrative battery tray for use in the battery containment structure of FIG. 1;

FIG. 14 depicts top detailed heat maps of a digital model of the battery tray of FIG. 13 after being subjected to a computer simulated stamping operation;

FIG. 15 depicts a perspective heat map of a digital model of the battery tray of FIG. 13 after being subjected to a computer simulated ballistics impact; and

FIG. 16 depicts a plot of force versus displacement for the computer simulated ballistics impact of FIG. 13.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

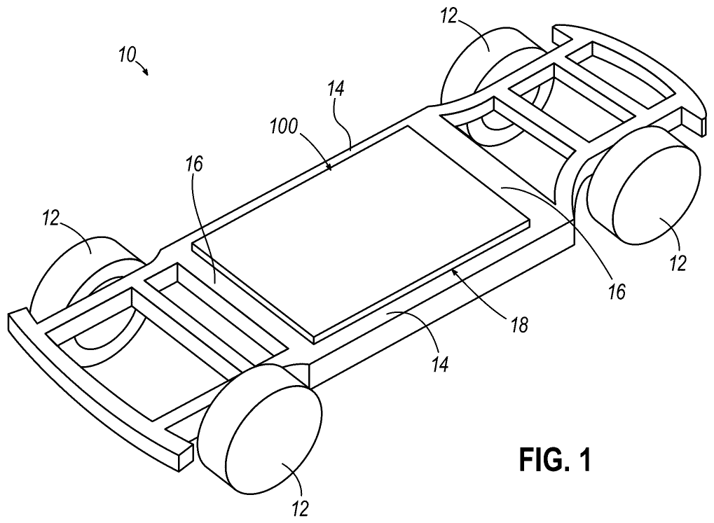

FIG. 1 shows an example of a vehicle chassis (10) generally configured for use as an electric vehicle chassis or a hybrid vehicle chassis. Vehicle chassis (10) supports a plurality of wheels (12) and includes one or more rails (14) and one or more cross-members (16). Rails (14) and cross-members (16) are generally interconnected to support wheels (12) and other structures associated with the vehicle (not shown) and to provide structural rigidity to vehicle chassis (10). Thus, rails (14) and cross-members (16) include a variety of rigid structural components such as tubular alloy structures to provide such structural rigidity to vehicle chassis (10).

A combination of rails (14) and cross-members (16) additionally define a battery receiving area (18). As will be described in greater detail below, battery receiving area (18) is generally configured to receive a battery containment structure (100), which may enclose one or more features of a vehicle battery assembly (200) such as one or more battery cells (210). It may be desirable for vehicle chassis (10) to define battery receiving area (18) because integration of vehicle battery assembly (200) into chassis (10) may to provide a low center of gravity and provide protection to components of vehicle battery assembly (200) such as battery cells (210). It should be understood that in other examples, battery receiving area (18) may be omitted and battery containment structure (100) may be positioned or integrated into other structures of the vehicle. Thus, battery receiving area (18) is optional and may be omitted in some examples.

As will be described in greater detail below, vehicle battery assembly (200) may be configured in a variety of ways. Suitable configurations include a variety of shapes and sizes. Such configurations may depend on a variety of factors such as the particular power configuration used (e.g., full electric versus hybrid) and/or other electrical needs of the vehicle. By way of example only, vehicle battery assembly (200) includes one or more battery cells (210), various combinations of suitable electronics and/or other related components (not shown). Battery cells (210) may include a variety of configurations. Examples of suitable configurations for battery cells (210) may include lithium-ion, lithium-polymer, lithium-metal, lead-acid, nickel-cadmium, nickel-metal hydride and/or other suitable configurations as will be apparent to those of ordinary skill in the art in view of the teachings herein.

Although use of battery containment structure (100) is described herein the particular context of vehicle battery assembly (200), it should be understood that battery containment structure (100) may be used with a variety of alternative vehicle battery assemblies. Alternative vehicle battery assemblies may include different battery cell configurations, battery wiring configurations, electronic configurations, battery cell locations, battery cell sizes, battery cell shapes, and/or etc.

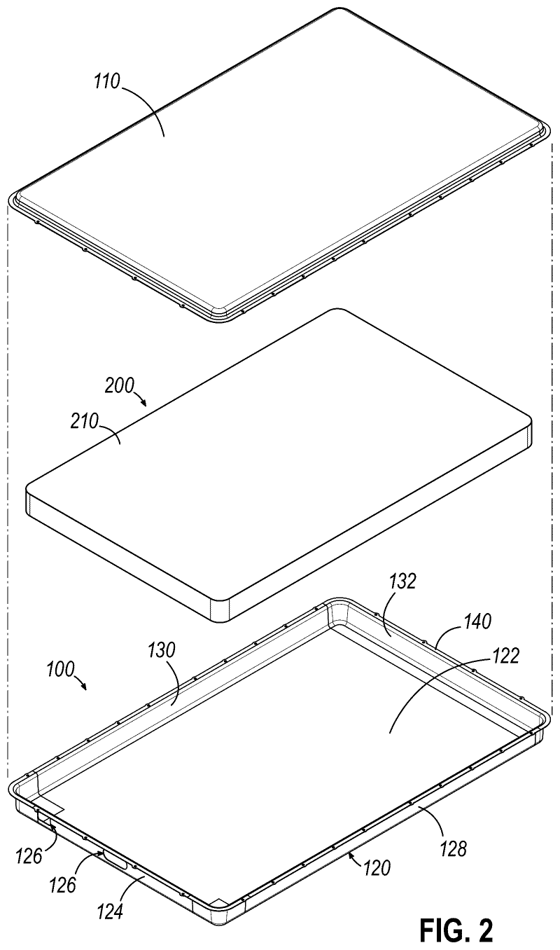

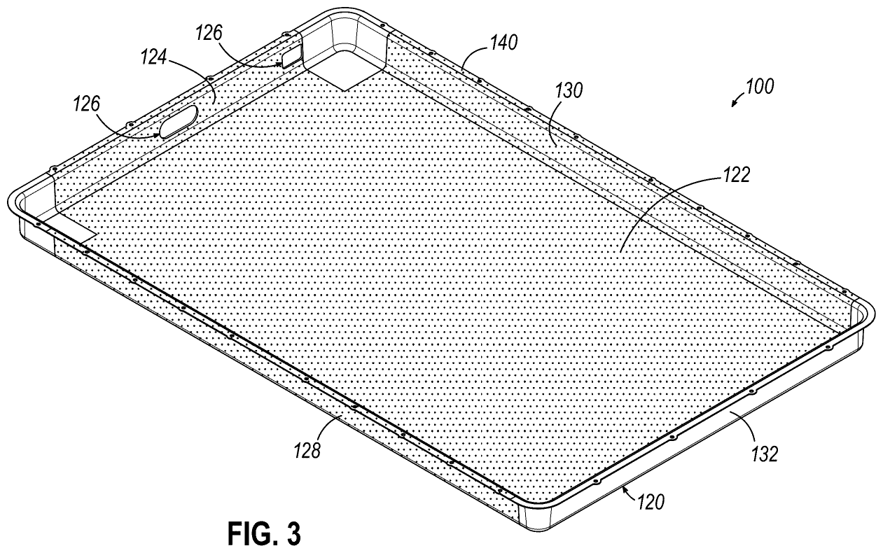

FIGS. 2 and 3 show battery containment structure (100) in more detail. Battery containment structure (100) is generally configured to contain and structurally protect one or more components of vehicle battery assembly (200), as will be described in greater detail below. Battery containment structure (100) includes a battery cover (110) and a battery tray (120). Battery cover (110) and battery tray (120) are configured to couple together to contain one or more components of vehicle battery assembly (200) (e.g., battery cells (210)) between battery cover (110) and battery tray (120). In some examples, the combination of battery cover (110) and battery tray (120) may be received within battery receiving area (18) of vehicle chassis (10) as described above.

Battery cover (110) defines a shape substantially corresponding to the shape of battery tray (120) and is generally configured to mate with battery tray (120). As will be described in greater detail below, battery tray (120) of the present example is generally rectangular in shape. Thus, battery cover (110) of the present example is likewise of a rectangular shape. Additionally, battery cover (110) defines at least some depth or hollow interior space to receive a portion of vehicle battery assembly (200) therein. Battery cover (110) of the present example includes a monolithic mild steel. In other examples, battery cover (110) may include one or more of the features described below with respect to battery tray (120). For instance, battery cover (110) may be formed of different materials welded together to form a single integral part. Optionally, battery cover (110) may include one or more geometric features configured to provide structural rigidity to battery cover (110). In other examples, battery cover (110) may be formed of a single steel material such as mild steel. In still other examples, battery cover (110) is entirely optional and may be omitted entirely.

Battery tray (120) is disposed beneath a portion of vehicle battery assembly (200) and below battery cover (110). Battery tray (120) is generally configured to receive a portion of vehicle battery assembly (200) (e.g., battery cells (210)) to contain the portion of vehicle battery assembly (200). Battery tray (120) is additionally generally configured to provide at least some protection to a portion of vehicle battery assembly (200). For instance, battery tray (120) is configured to provide stiffness and rigidity to protect a portion of vehicle battery assembly (200) from front and side impacts. Battery tray (120) is further configured to protect a portion of vehicle battery assembly (200) from ballistic impacts. Additionally, battery tray (120) is configured to protect a portion of vehicle battery assembly (200) from fluid ingress or egress by providing a barrier between the portion of vehicle battery assembly (200) and the exterior of battery tray (120). Various features that contribute to such protection of a portion of vehicle battery assembly (200) will be described in greater detail below.

As best seen in FIG. 3, battery tray (120) defines a floor (122) and a plurality of walls (124, 128, 130, 132) extending upwardly from floor (122). Floor (122) and walls (124, 128, 130, 132) together form a single piece of contiguous material, which defines a rectangular box shape configured to receive a portion of vehicle battery assembly (200) (e.g., battery cells (210)). Optionally, an upper portion of walls (124, 128, 130, 132) defines an upper lip (140) extending around the perimeter of battery tray (120) and configured to couple battery cover (110) to battery tray (120).

The interfaces between each wall (124, 128, 130, 132), as well as the interfaces between walls (124, 128, 130, 132) and floor (122), are generally of a curved, rounded, or radiused configuration. As will be described in greater detail below, battery tray (120) is configured for formation by stamping. Thus, curved, rounded, or radiused interfaces or edges may be desirable to promote ease of stamping.

Walls (124, 128, 130, 132) include a front wall (124), a rear wall (132) and a pair of sidewalls (128, 130) extending between front wall (124) and rear wall (132). Optionally, one or more of walls (124, 128, 130, 132) define one or more openings (126) therein. Openings (126) may be desirable to permit one or more features of vehicle battery assembly (200) to pass through battery tray (120) such as wires, cables, and/or etc. In the present example, two openings are defined by front wall (124). Although in other examples, a variety of alternative configurations for openings (126) may be used.

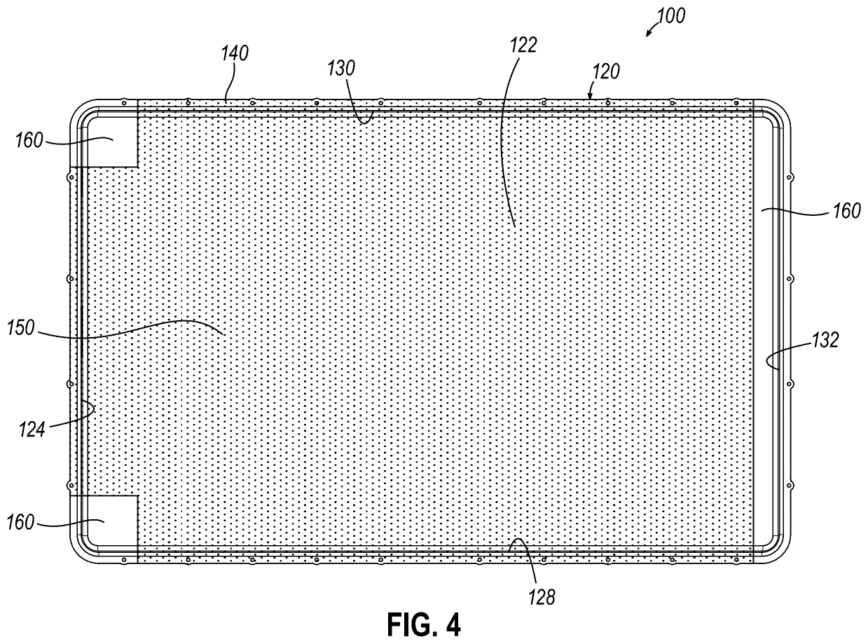

As best seen in FIG. 4, battery tray (120) is formed of a multi-material configuration. In particular, battery tray (120) includes a high strength material (150) and a high formability material (160). High strength material (150) and high formability material (160) are joined together to form a single contiguous part. High strength material (150) is generally configured to provide stiffness and strength to battery tray (120) to resist side and front impacts and provide ballistic protection. Meanwhile, high formability material (160) is generally configured to provide formability to portions of battery tray (120) to permit stamping of battery tray (120) from a flat blank.

High strength material (150) and high formability material (160) are positioned at particular locations about battery tray (120) to provide a suitable combination of stiffness, strength, and formability. For instance, high strength material (150) defines a substantial portion of floor (122) and extends into front wall (124) and sidewalls (128, 130) to provide high strength and stiffness in regions of battery tray (120) that may be susceptible to front impacts (e.g., front wall (124)), side impacts (e.g., sidewalls (128, 130)), and ballistic impacts (e.g., floor (122)). Meanwhile, high formability material (160) is positioned in regions of battery tray (120) where bending forces may be concentrated during stamping. Thus, in the present version, high formability material (160) is positioned at the corners defined by front wall (124), sidewalls (128, 130), and floor (122). Additionally, high formability material (160) defines the entirety of rear wall (132) and a portion of floor (122) adjacent to rear wall (132). Although the high strength material (150) and high formability material (160) are shown as being in particular positions in the present example, it should be understood that in other examples, the positioning of high strength material (150) and high formability material (160) may be varied due to a variety of factors. Such factors may include the particular shape or structural configuration of battery tray (120) or particular vehicle applications for battery tray (120). For instance, in some vehicle applications, rear impacts may also be considered. Thus, in such applications, rear wall (132) may have a material positioning similar to front wall (124) described above.

High strength material (150) and high formability material (160) both generally include a steel material of different grades. For instance, in the present example, high strength material (150) includes M1700 grade steel. In other examples, high strength material (150) includes advanced high-strength steel (AHSS) grades or ultra-high strength steel (UHSS) grades. Similarly, in the present example, high formability material (160) includes CR5 grade steel. In other examples, high formability material (160) includes other mild steel grades. Alternatively, in some examples, high strength material (150) and/or high formability material (160) may include one or more press hardening steels (PHS) of various grades. For instance, in some examples, high strength material (150) includes a PHS material grade of 1500 MPa or more, while high formability material (160) includes a PHS material grade of less than 1500 MPa. In such examples, high strength material (150) and high formability material (160) may be positioned as described herein to provide desirable variation in material properties. In yet other examples, battery tray (120) may be of a monolithic structure of a PHS material.

Both high strength material (150) and high formability material (160) generally define a uniform thickness. For instance, in the present example both high strength material (150) and high formability material (160) define a thickness of about 2 mm. In other examples, the thickness may be varied depending on the particular material used for high strength material (150) and high formability material (160). For instance, in examples where high strength material (150) is of higher or lower strength than M1700 grade steel, a thickness of less than or greater than 2 mm may be used, respectively, while still achieving similar performance. In addition, or in the alternative, the thickness of high formability material (160) may likewise be varied depending on the formability characteristics of the particular material used. In still other examples, high strength material (150) may define one thickness, while high formability material (160) may define another thickness. As similarly discussed above, such differing thicknesses may be used to meet similar performance, while varying the particular materials used for high strength material (150) and/or high formability material (160).

High strength material (150) and high formability material (160) are generally joined by one or more welding processes. Such joining may provide a continuously sealed interface, which may protect a portion of vehicle battery assembly (200) from fluid ingress or egress. A variety of welding processes may be used. For instance, in some examples, high strength material (150) and high formability material (160) are joined by one or more fusion welding processes such as laser welding or arc welding. In other examples, high strength material (150) and high formability material (160) are joined by one or more forging processes such as flash butt-welding or friction stir welding. In yet other examples, high strength material (150) and high formability material (160) are joined by a combination of fusion and forging welding processes.

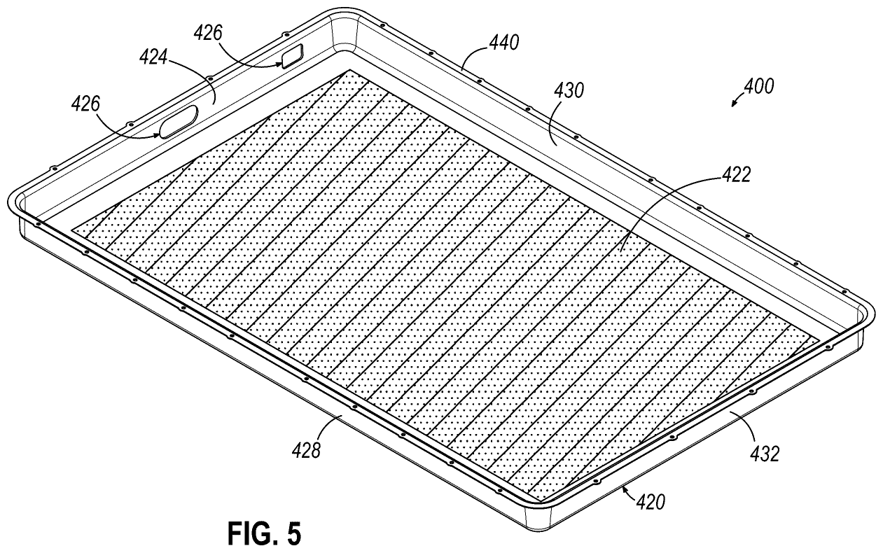

FIG. 5 shows an illustrative alternative battery tray (420), which may be incorporated into battery containment structure (100) in lieu of battery tray (120) described above. As with battery tray (120) described above, battery tray (420) of the present example defines a floor (422) and a plurality of walls (424, 428, 430, 432) extending upwardly from floor (422). Floor (422) and walls (424, 428, 430, 432) together form a single piece of contiguous material, which defines a rectangular box shape configured to receive a portion of vehicle battery assembly (200) (e.g., battery cells (210)). Optionally, an upper portion of walls (424, 428, 430, 432) defines an upper lip (440) extending around the perimeter of battery tray (420) and configured to couple battery cover (110) to battery tray (420).

The interfaces between each wall (424, 428, 430, 432), as well as the interfaces between walls (424, 428, 430, 432) and floor (422), are generally of a curved, rounded, or radiused configuration. Similar to battery tray (120) described above, battery tray (420) of the present example is configured for formation by stamping. Thus, curved, rounded, or radiused interfaces or edges may be desirable to promote ease of stamping.

Walls (424, 428, 430, 432) include a front wall (424), a rear wall (432) and a pair of sidewalls (428, 430) extending between front wall (424) and rear wall (432). Optionally, one or more of walls (424, 428, 430, 432) define one or more openings (426) therein. Openings (426) may be desirable to permit one or more features of vehicle battery assembly (200) to pass through battery tray (420) such as wires, cables, and/or etc. In the present example, two openings are defined by front wall (424). Although in other examples, a variety of alternative configurations for openings (426) may be used.

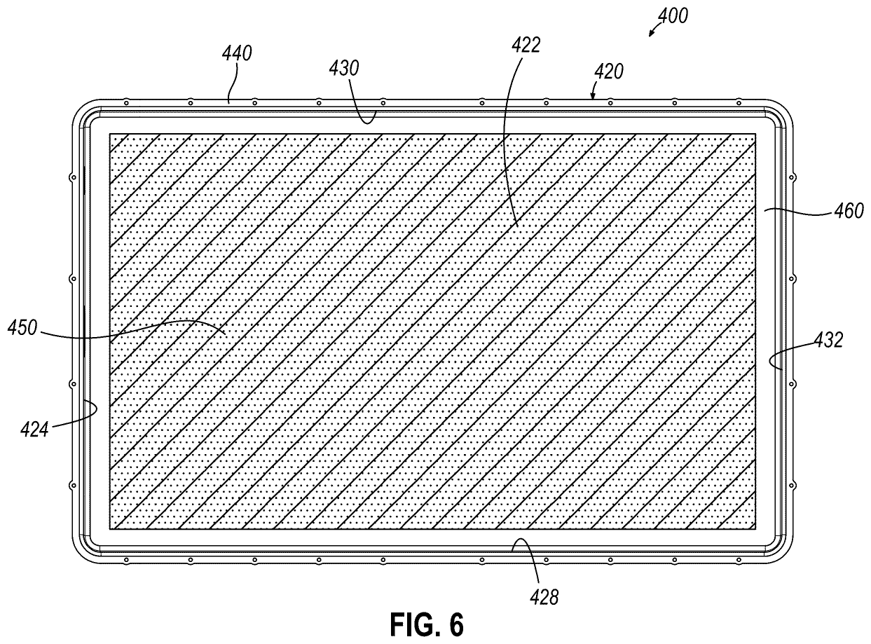

As best seen in FIG. 6, battery tray (420) is formed of a multi-material configuration. In particular, battery tray (420) includes a high strength material (450) and a high formability material (460). High strength material (450) and high formability material (460) are joined together to form a single contiguous part. High strength material (450) is generally configured to provide stiffness and strength to battery tray (420) to resist side and front impacts and provide ballistic protection. Meanwhile, high formability material (460) is generally configured to provide formability to portions of battery tray (420) to permit stamping of battery tray (420) from a flat blank.

Like in battery tray (120) described above, high strength material (450) and high formability material (460) are positioned at particular locations about battery tray (420) to provide a suitable combination of stiffness, strength, and formability. However, unlike battery tray (120) described above, high strength material (450) and high formability material (460) are isolated to different regions of battery tray (420) to provide varying performance characteristics with respect to battery tray (120). For instance, high strength material (450) defines a substantial portion of floor (422) and terminates before intersecting with walls (424, 428, 430, 432) or the curved interfaces associated with walls (424, 428, 430, 432). In other words, high strength material (450) is generally isolated to floor (422) in the present example. In the present example, high strength material (450) forms a substantial majority of floor (422). In some examples, high strength material (450) is over 60% of the area of floor (422). In other examples, high strength material (450) is over 80% of the area of floor (422). In yet other examples, high strength material (450) is over 90% of the area of floor (422). In still other examples, high strength material (450) occupies the entire portion of floor (422) not subjected to bending forces during stamping. In such examples, high strength material (430) defines a substantially flat or planar portion of floor (422), while high formability material (460) defines any non-flat or non-planar portions of floor (422).

High formability material (460) is positioned in regions of battery tray (420) where bending forces may be concentrated during stamping. Thus, in the present version, high formability material (460) is positioned at the corners defined by front wall (124), sidewalls (128, 130), and floor (122), and the interfaces between floor (422) and walls (424, 428, 430, 432). Additionally, high formability material (460) defines the entirety of front wall (424) rear wall (432) and at least a portion of floor (422) adjacent to each wall (424, 428, 430, 432). The configuration of high strength material (450) and high formability material (460) in the present example is generally desirable to manage distortions in battery tray (420), particularly during and after stamping. By isolating high strength material (450) to floor (422), the material properties of regions subjected to bending forces are more consistent, while the regions that may be subjected to impacts are strengthened using high strength material (450).

High strength material (450) and high formability material (460) both generally include a steel material of different grades. For instance, in the present example, high strength material (450) includes M1500 or M1700 grade steel. In other examples, high strength material (450) includes advanced high-strength steel (AHSS) grades or ultra-high strength steel (UHSS) grades. Similarly, in the present example, high formability material (460) includes a mild grade steel such as CR5 grade steel. In other examples, high formability material (460) includes other mild steel grades. Alternatively, in some examples, high strength material (450) and/or high formability material (460) may include one or more press hardening steels (PHS) of various grades. For instance, in some examples, high strength material (450) includes a PHS material grade of 1500 MPa or more, while high formability material (460) includes a PHS material grade of less than 1500 MPa. In such examples, high strength material (450) and high formability material (460) may be positioned as described herein to provide desirable variation in material properties. In yet other examples, battery tray (420) may be of a monolithic structure of a PHS material.

Both high strength material (450) and high formability material (460) generally define a uniform thickness. For instance, in the present example both high strength material (450) and high formability material (460) define a thickness of about 2 mm. In other examples, the thickness may be varied depending on the particular material used for high strength material (450) and high formability material (460). For instance, in examples where high strength material (450) is of higher or lower strength than M1500 or M1700 grade steel, a thickness of less than or greater than 2 mm may be used, respectively, while still achieving similar performance. In addition, or in the alternative, the thickness of high formability material (460) may likewise be varied depending on the formability characteristics of the particular material used. In still other examples, high strength material (450) may define one thickness, while high formability material (460) may define another thickness. As similarly discussed above, such differing thicknesses may be used to meet similar performance, while varying the particular materials used for high strength material (450) and/or high formability material (460).

High strength material (450) and high formability material (460) are generally joined by one or more welding processes. Such joining may provide a continuously sealed interface, which may protect a portion of vehicle battery assembly (200) from fluid ingress or egress. A variety of welding processes may be used. For instance, in some examples, high strength material (450) and high formability material (460) are joined by one or more fusion welding processes such as laser welding or arc welding. In other examples, high strength material (450) and high formability material (460) are joined by one or more forging processes such as flash butt-welding or friction stir welding. In yet other examples, high strength material (450) and high formability material (460) are joined by a combination of fusion and forging welding processes.

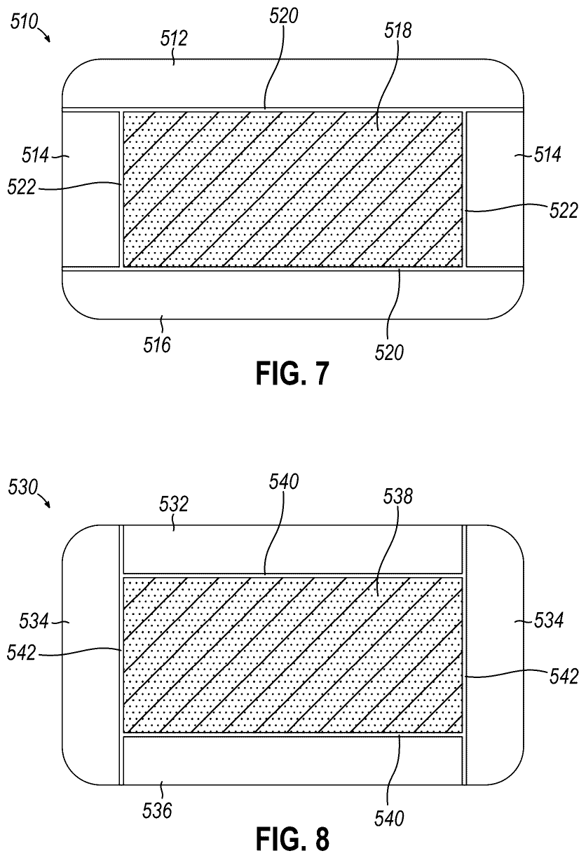

Joining of high strength material (450) and high formability material (460) may be performed in a variety of patterns using a variety of weld paths. For instance, FIG. 7 shows a blank (510), which may be used to form battery tray (420). Blank (510) includes one merely illustrative joining configuration. In this configuration, blank (510) is formed by two relatively long and continuous horizontal welds (520) and two relatively short and continuous vertical welds (522). Additionally, the vertical welds (522) intersect and terminate at respective horizontal welds (520). For ease of manufacturability, high formability material (460) can be divided into 4 or more segments with two relatively long top and bottom segments (512, 516) and two relatively short side segments (514). In this configuration, side segments (514) are disposed between top segment (512) and bottom segment (516). All segments (512, 514, 516) are generally rectangular with some rounded corners. Such segments (512, 514, 516) can be welded directly to a single generally rectangular middle segment (518) including high strength material (450).

FIG. 8 shows another blank (530), which may be used to form battery tray (420). Blank (530) includes an alternative merely illustrative joining configuration. In this configuration, blank (530) is formed by two relatively long and continuous horizontal welds (540) and two relatively long and continuous vertical welds (542). Additionally, the horizontal welds (540) intersect and terminate at respective vertical welds (542). For ease of manufacturability, high formability material (460) can be divided into 4 or more segments with a top segment (532), a bottom segment (536), and two side segments (534). In this configuration, top segment (532) and bottom segment (536) are disposed between side segments (534). All segments (532, 534, 536) are generally rectangular with some rounded corners. Such segments can be welded directly to a single generally rectangular middle segment (538) including high strength material (450).

### Example 1

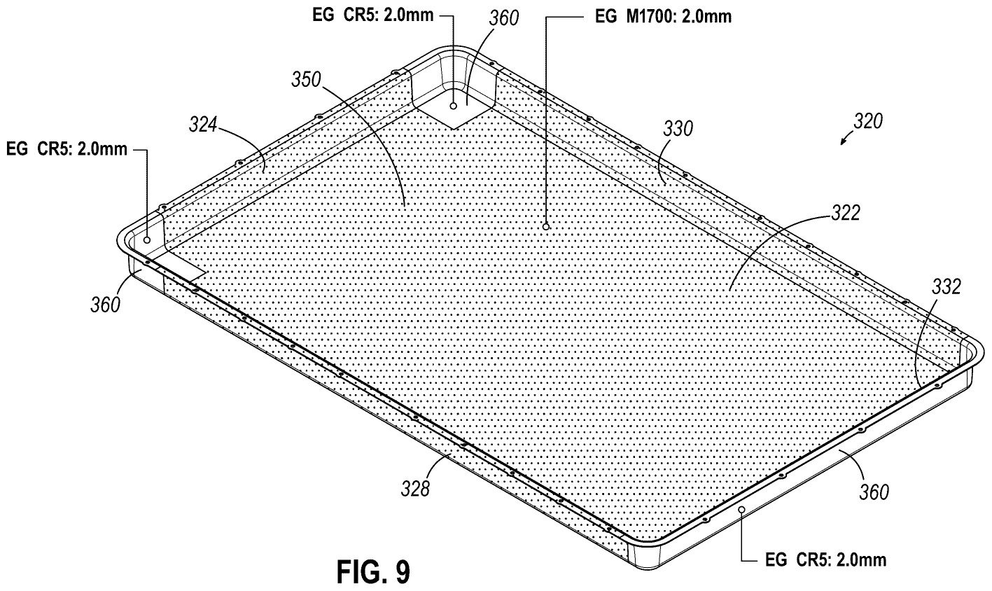

FIG. 9 shows a first test battery tray (320) that was prepared substantially similarly to battery tray (120) described above. As with battery tray (120) described above, first test battery tray (320) was prepared to include a floor (322) and a front wall (324), sidewalls (328, 330) and a rear wall (332) extending upwardly from floor (322). First test battery tray (320) was also prepared with a multi-material configuration including a high strength material (350) of M1700 grade steel and a high formability material (360) of CR5 grade steel. Both high strength material (350) and high formability material (360) were positioned as described above with respect to high strength material (150) and high formability material (160). The thickness of both high strength material (350) and high formability material (360) was about 2 mm.

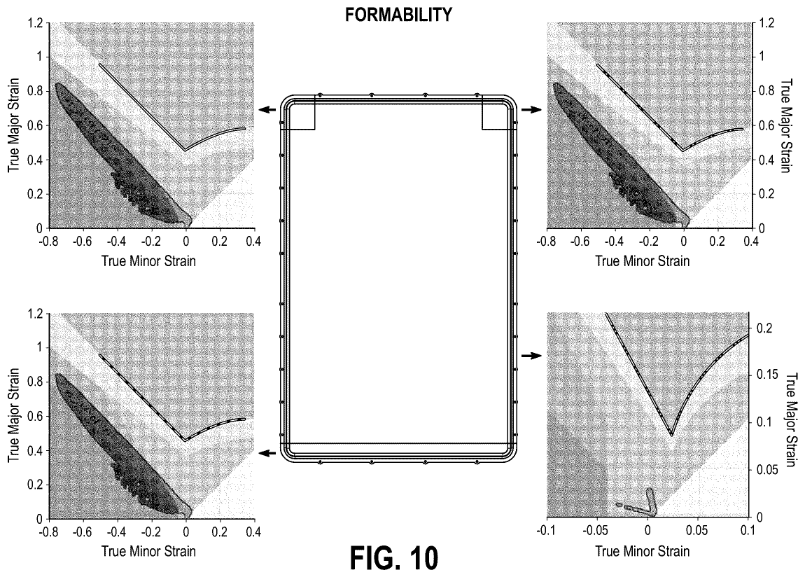

A computer-generated model of first test battery tray (320) was generated using AUTOFORM software, software for digitally simulating stamping. Stamping of the computer-generated model of first test battery tray (320) was then simulated using the AUTOFORM software. Heatmaps of the forces generated during the simulated stamping operation were generated using the software and are reproduced in FIG. 10. A successful stamping operation was observed.

### Example 2

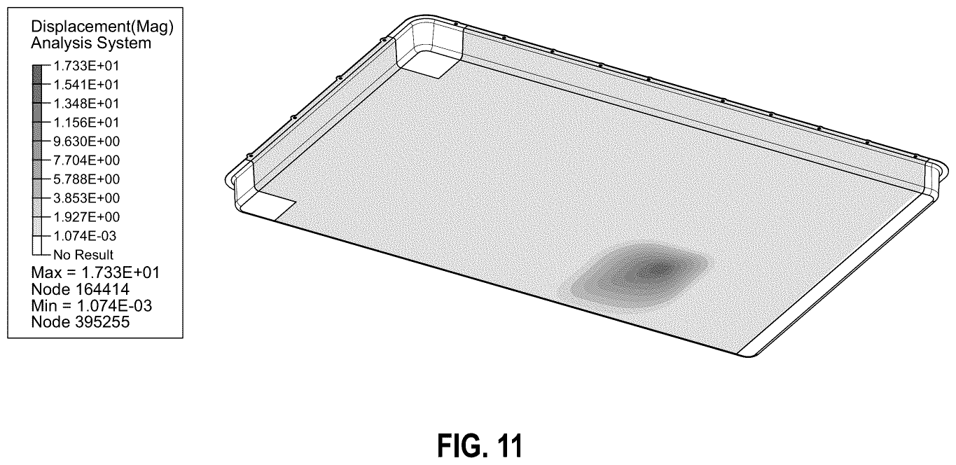

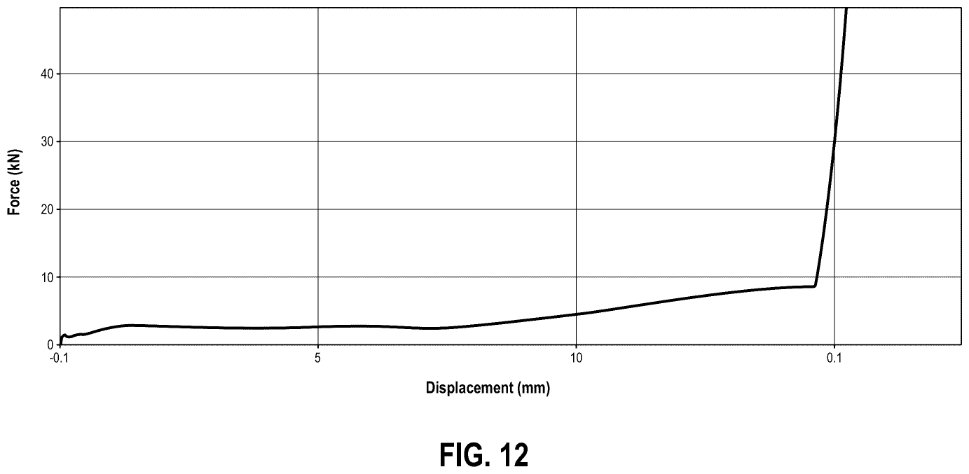

The computer-generated model of first test battery tray (320) was then used for digital simulation of a ballistic impact to floor (322). A heatmap of the forces generated during the simulated ballistic impact was generated and is reproduced in FIG. 11. Additionally, a force versus displacement curve of the computer-generated model of first test battery tray (320) was generated and is reproduced in FIG. 12. One ballistic impact standard was to avoid contact with vehicle battery assembly (200) before reaching 35 KN when loaded with a 20 mm round rigid impactor. It was observed that this standard was met based on the heatmap reproduced in FIG. 11 and the force versus displacement curve reproduced in FIG. 12.

### Example 3

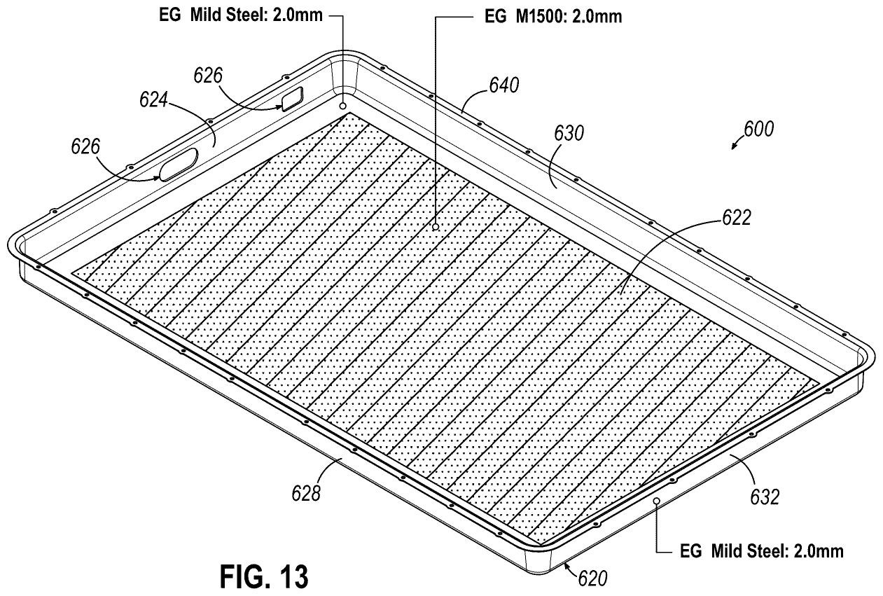

FIG. 13 shows a second test battery tray (620) that was prepared substantially similarly to battery tray (420) described above. As with battery tray (420) described above, second test battery tray (620) was prepared to include a floor (622) and a front wall (624), sidewalls (628, 630) and a rear wall (632) extending upwardly from floor (622). Second test battery tray (620) was also prepared with a multi-material configuration including a high strength material (650) of M1500 grade steel and a high formability material (660) of mild steel. Both high strength material (650) and high formability material (660) were positioned as described above with respect to high strength material (450) and high formability material (460). The thickness of both high strength material (650) and high formability material (660) was about 2 mm.

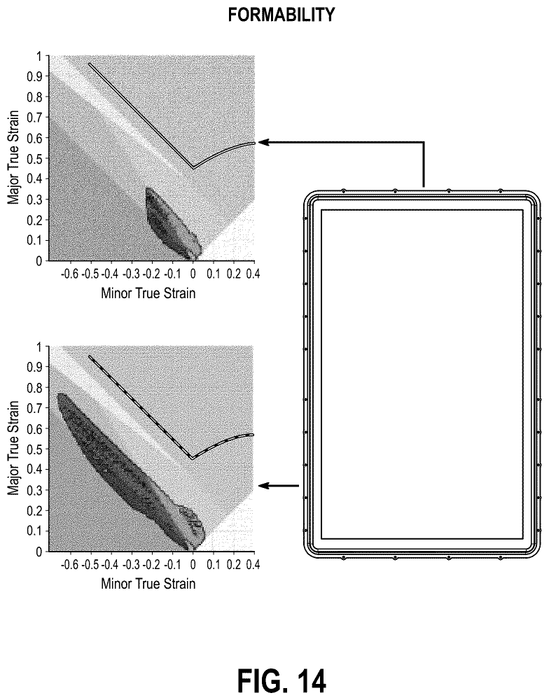

A computer-generated model of second test battery tray (620) was generated using AUTOFORM software, software for digitally simulating stamping. Stamping of the computer-generated model of second test battery tray (620) was then simulated using the AUTOFORM software. Heatmaps of the forces generated during the simulated stamping operation were generated using the software and are reproduced in FIG. 14. A successful stamping operation was observed.

### Example 4

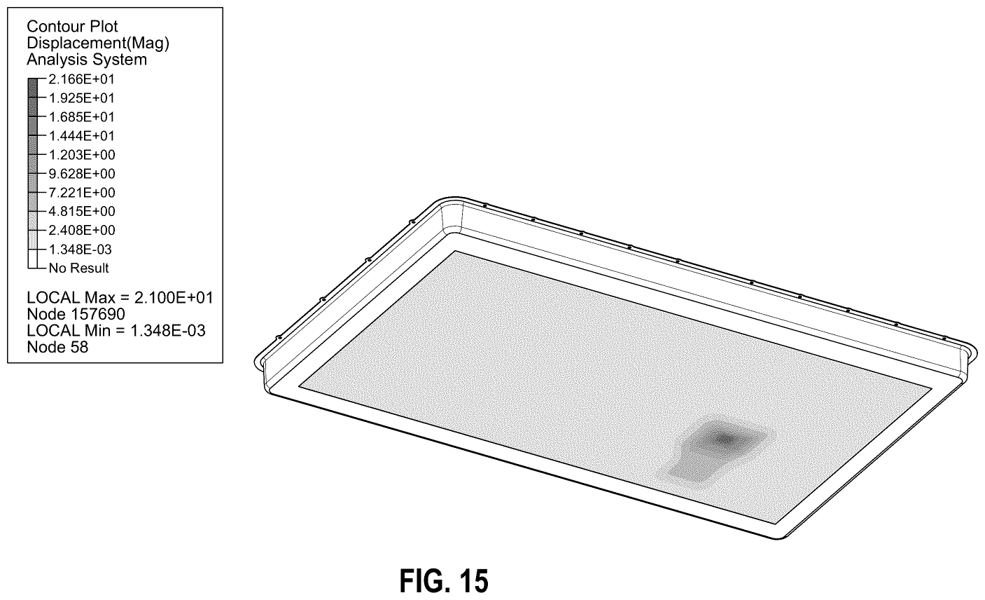

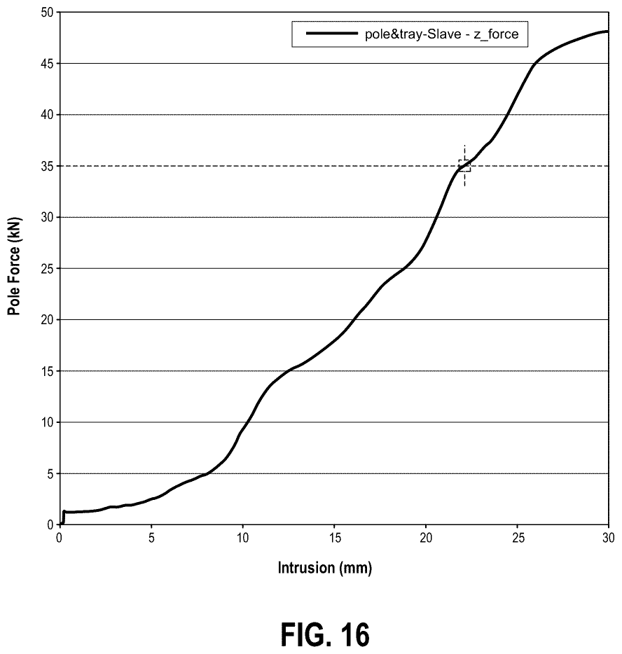

The computer-generated model of second test battery tray (620) was then used for digital simulation of a ballistic impact to floor (622) using software called HyperMesh & LS-DYNA. A heatmap of the forces generated during the simulated ballistic impact was generated and is reproduced in FIG. 15. Additionally, a force versus displacement curve of the computer-generated model of second test battery tray (620) was generated and is reproduced in FIG. 16. One ballistic impact standard was to avoid contact with vehicle battery assembly (200) before reaching 35 KN when loaded with a 20 mm diameter rigid impactor. It was observed that this standard was met based on the heatmap reproduced in FIG. 15 and the force versus displacement curve reproduced in FIG. 16.

### Example 5

A physical sample of second test battery tray (620) was prepared and subjected to flatness assessment. Specifically, a flange structure similar to upper lip (440) described above was measured for flatness variation. The variation in flatness was measured using a coordinate measuring machine. The flatness was observed as within ±1.5 mm over a length of 2,100 mm.

### Example 6

The physical sample of Example 5 was next subjected to a leak test. In the leak test, the physical sample was placed in a tank with the open side down. The flange structure of the physical sample was positioned against a gasket, which was positioned on top of a plate simulating a structure such as battery cover (110). The interior of the physical sample was pressurized to a pressure of 0.5 psi. The tank was filled with water. No leak was observed for over 15 minutes, i.e., leak rate of 0 Standard Cubic Centimeter per Minute (SCCM) versus the standard allowable rate of up to 15 SCCM.

### Example 7

An apparatus for containing a portion of a vehicle battery assembly, the apparatus comprising: a tray configured to receive the portion of the vehicle battery assembly, the tray defining a floor, a front wall, a rear wall, and a pair of sidewalls extending from the front wall to the rear wall, the tray including a first steel material and a second steel material, the first steel material being joined with the second steel material to form a single contiguous part, the first material defining a substantial majority of the floor, the second material being disposed at two or more corners of the tray.

### Example 8

The apparatus of Example 7, the tray defining one or more openings, each opening of the one or more openings being configured to receive a portion of the vehicle battery assembly.

### Example 9

The apparatus of Examples 7 or 8, further comprising a cover, the tray being configured to receive the cover.

### Example 10

The apparatus of Example 9, the tray defining a lip extending from the front wall, the rear wall, and the pair of sidewalls, the lip being configured to mate with the cover.

### Example 11

The apparatus of any of Examples 7 through 10, the first steel material and the second steel material being joined by a weld.

### Example 12

The apparatus of Example 7, the weld being a fusion or forged weld.

### Example 13

The apparatus of any of Examples 7 through 12, the second steel material being disposed at each corner defined by the interface between the floor, the front wall, and the pair of sidewalls.

### Example 14

The apparatus of any of Examples 7 through 13, the second steel material defining the entirety of the rear wall.

### Example 15

The apparatus of any of Examples 7 through 13, the second steel material defining a rear portion of the floor.

### Example 16

The apparatus of any of Examples 7 through 15, the first steel material including a first grade of steel, the second steel material including a second grade of steel, the first grade of steel being different from the second grade of steel.

### Example 17

The apparatus of any of Examples 7 through 15, the first steel material including a first grade of steel, the second steel material including a second grade of steel, the first grade of steel being an ultra-high strength steel grade or an advanced high-strength steel grade, the second grade of steel being a mild steel grade.

### Example 18

The apparatus of any of Examples 7 through 15, the first steel material including a first grade of steel, the second steel material including a second grade of steel, the first grade of steel being an M1700 grade or an M1500 grade.

### Example 19

The apparatus of Example 18, the second grade of steel being a CR5 grade.

### Example 20

The apparatus of any of Examples 7 through 19, the first steel material defining a substantially flat portion of the floor.

### Example 21

The apparatus of any of Examples 7 through 19, the first steel material defining a planar portion of the floor, the second steel material defining any non-planar portion of the floor.

### Example 22

The apparatus of Example 21, the first steel material being isolated to the floor.

### Example 23

A method for containing a portion of a vehicle battery assembly within a tray, the method comprising: welding a first steel material to a second steel material to form a single contiguous steel plate; forming the tray by stamping the single contiguous steel plate, the formed tray having a hollow interior; and inserting a portion of the vehicle battery assembly into the hollow interior of the formed tray.

### Example 24

The method of Example 23, further comprising positioning the first steel material and the second steel material relative to each other prior to welding with the second steel material being positioned at one or more corners of the first steel material.

### Example 25

The method of Example 24, the step of positioning the first steel material and the second steel material relative to each other including positioning a first portion of the second steel material at a first corner of the first steel material and positioning a second portion of the second steel material at a second corner of the first steel material.

### Example 26

The method of Example 25, the step of positioning the first steel material and the second steel material relative to each other including positioning a third portion of the second steel material at an edge of the first steel material opposite of the first corner and the second corner.

### Example 27

The method of any of Examples 23 through 26, the step of welding including forming one or more continuous welds between the first steel material and the second steel material.

### Example 28

The method of any of Examples 23 through 27, the step of welding including welding the first material to the second material using a fusion welding process.

### Example 29

The method of Example 28, the fusion welding process including laser or arc welding.

### Example 30

The method of any of Examples 23 through 27, the step of welding including welding the first material to the second material using a forging welding process.

### Example 31

The method of Example 30, the forging welding process including friction stir or flash butt welding.

### Example 32

An apparatus for containing a portion of a vehicle battery assembly, the apparatus comprising: a battery cover; and a battery tray, the battery tray including a front wall, a rear wall, a pair of sidewalls, and a floor, the front wall, the rear wall, and the pair of sidewalls extending upwardly from the floor to define an interface between the front wall, the rear wall, the pair of sidewalls, and the floor, the front wall, the rear wall, and the pair of sidewalls together defining an upper lip, the upper lip being configured to receive the battery cover to form a cavity for receipt of a portion of the vehicle battery assembly therein, the battery tray being formed of a high strength material and a high formability material joined together to form a single tray, the high strength material defining at least a portion of the floor, the high formability material defining the front wall, the rear wall, the pair of sidewalls and the interface.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of any claims that may be presented and is understood not to be limited to the details of structure and operation shown and described in the specification and drawings.

1. An apparatus for containing a portion of a vehicle battery assembly, the apparatus comprising:
a tray configured to receive the portion of the vehicle battery assembly, the tray defining a floor, a front wall, a rear wall, and a pair of sidewalls extending from the front wall to the rear wall,
the tray including a first steel material and a second steel material, the first steel material being joined with the second steel material to form a single contiguous part, the first steel material defining a substantial majority of the floor, the second steel material being disposed at two or more corners of the tray.

2. The apparatus of claim 1, the tray defining one or more openings, each opening of the one or more openings being configured to receive a portion of the vehicle battery assembly.

3. The apparatus of claim 1, further comprising a cover, the tray being configured to receive the cover.

4. The apparatus of claim 3, the tray defining a lip extending from the front wall, the rear wall, and the pair of sidewalls, the lip being configured to mate with the cover.

5. The apparatus of claim 1, the first steel material and the second steel material being joined by a weld.

6. (canceled)

7. The apparatus of claim 1, the second steel material being disposed at each corner defined by the interface between the floor, the front wall, and the pair of sidewalls.

8. The apparatus of claim 1, the second steel material defining the entirety of the rear wall.

9. The apparatus of claim 1, the second steel material defining a rear portion of the floor.

10. (canceled)

11. The apparatus of claim 1, the first steel material including a first grade of steel, the second steel material including a second grade of steel, the first grade of steel being an ultra-high strength steel grade or an advanced high-strength steel grade, the second grade of steel being a mild steel grade.

12. (canceled)

13. The apparatus of claim 1, the first steel material including a first grade of steel, the second steel material including a second grade of steel, the first grade of steel being an M1700 grade or an M1500 grade.

14. The apparatus of claim 13, the second grade of steel being a CR5 grade.

15. The apparatus of claim 1, the first steel material defining a substantially flat portion of the floor.

16. The apparatus of claim 1, the first steel material defining a planar portion of the floor, the second steel material defining any non-planar portion of the floor.

17. The apparatus of claim 16, the first steel material being isolated to the floor.

18. A method for containing a portion of a vehicle battery assembly within a tray, the method comprising:
welding a first steel material to a second steel material to form a single contiguous steel plate;
forming the tray by stamping the single contiguous steel plate, the formed tray having a hollow interior; and
inserting a portion of the vehicle battery assembly into the hollow interior of the formed tray.

19. The method of claim 18, further comprising positioning the first steel material and the second steel material relative to each other prior to welding with the second steel material being positioned at one or more corners of the first steel material.

20. The method of claim 19, the step of positioning the first steel material and the second steel material relative to each other including positioning a first portion of the second steel material at a first corner of the first steel material and positioning a second portion of the second steel material at a second corner of the first steel material.

21. The method of claim 20, the step of positioning the first steel material and the second steel material relative to each other including positioning a third portion of the second steel material at an edge of the first steel material opposite of the first corner and the second corner.

22. The method of claim 18, the step of welding including forming one or more continuous welds between the first steel material and the second steel material.

23.-26. (canceled)

27. An apparatus for containing a portion of a vehicle battery assembly, the apparatus comprising:
(a) a battery cover; and
(b) a battery tray, the battery tray including a front wall, a rear wall, a pair of sidewalls, and a floor, the front wall, the rear wall, and the pair of sidewalls extending upwardly from the floor to define an interface between the front wall, the rear wall, the pair of sidewalls, and the floor, the front wall, the rear wall, and the pair of sidewalls together defining an upper lip, the upper lip being configured to receive the battery cover to form a cavity for receipt of a portion of the vehicle battery assembly therein,
the battery tray being formed of a high strength material and a high formability material joined together to form a single tray, the high strength material defining at least a portion of the floor, the high formability material defining the front wall, the rear wall, the pair of sidewalls and the interface.
